(19) United States
(12) Patent Application Publication
(10) Pub. No.: US 2013/0335196 A1
(43) Pub. Date: Dec. 19, 2013

(54) USING TOUCH PAD TO REMOTE CONTROL HOME ELCTRONICS LIKE TV

(71) Applicants: Hong ZHANG, Redmond, WA (US); Li Yin, Redmond, WA (US); Zhe Wang, Sammamish, WA (US); Zhengping Zuo, Sammamish, WA (US)

(72) Inventors: Hong ZHANG, Redmond, WA (US); Li Yin, Redmond, WA (US); Zhe Wang, Sammamish, WA (US); Zhengping Zuo, Sammamish, WA (US)

(73) Assignee: Google Inc.

(21) Appl. No.: 13/525,212

(22) Filed: Jun. 15, 2012

(51) Int. Cl. H04Q 5/22; G06F 3/041

(52) U.S. Cl. 340/10.1

(57) ABSTRACT

Apparatus and methods of a remote control device are provided. The remote control device includes a switch and a power input. The remote control device also includes a touch panel configured to operate in an absence of backlight. The touch panel is configured to receive a first input at a first area of the touch panel and a second input at a second area of the touch panel. The remote control device includes a processing unit configured to provide first control data representing the first input and second control data representing the second input. The first control data can control movement of a cursor on the electronic device. The second control data can identify text corresponding to the second input. The remote control device includes a transmitter configured to provide the control data to the electronic device.

### BACKGROUND

A remote control is an electronic device which can be used to operate other electronic devices wirelessly from a distance. The electronic devices being controlled include televisions, set top boxes, digital video recorders, smart televisions, computers, monitors, tablet computers, or smart phones, for example.

### SUMMARY

At least one aspect is directed to a remote control device. The remote control device includes a switch configured to activate and deactivate both an electronic device and the remote control device. The remote control device also includes a power input configured to receive electrical power. The remote control device further includes a touch panel configured to operate in an absence of backlight. The touch panel is configured to receive a first input at a first area of the touch panel and a second input at a second area of the touch panel. The remote control device also includes a processing unit which is coupled with the switch, the power input, and the touch panel. The processing unit is configured to provide first control data representing the first input and second control data representing the second input. The first control data can control movement of a cursor on the electronic device. The second control data can identify text corresponding to the second input. The remote control device also include a transmitter which is coupled to the processing unit. The transmitter is configured to provide the control data to the electronic device.

At least one aspect is directed to a remote control device. The remote control device includes a switch configured to activate and deactivate both an electronic device and the remote control device. The remote control device also includes a power input configured to receive electrical power. The remote control device further includes a touch panel configured to operate in an absence of backlight. The touch panel is configured to receive a first input at a first area of the touch panel and a second input at a second area of the touch panel. The remote control device also includes a means for providing first control data representing the first input and second control data representing the second input. The first control data can control movement of a cursor on the electronic device. The second control data can identify text corresponding to the second input. The remote control device also includes a transmitter which is configured to provide the control data from the remote control device to the electronic device.

At least one aspect is directed to a method of remotely controlling an electronic device. The method receives a user input at a remote control device. The remote control device includes a switch which is configured to activate and deactivate both an electronic device and the remote control device. The remote control device also includes a power input configured to receive electrical power. The remote control device further includes a touch panel which is configured to operate in an absence of backlight. The touch panel is configured to receive a first input at a first area of the touch panel and a second input at a second area of the touch panel. The remote control device also includes a processing unit which is coupled with the switch, the power input, and the touch panel. The remote control device additionally includes a transmitter which is coupled to the processing unit. The method evaluates, using the processing unit, the user input to identify the input as one of the first input and the second input. The first input can be received at the first area of the touch panel and the second input can be received at the second area of the touch panel. The method generates, using the processing unit, control data representing the user input. The control data can be one of a first control data and a second control data. The first control data may represent the first input to control movement of a cursor on the electronic device. The second control data may represent the second input to identify text corresponding to the second input. The method also transmits, using the transmitter, at least one of the first control data and the second control data from the remote control device to a receiver of the electronic device to control at least one of a cursor display and a text display on the electronic device.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example of a remote control device, according to an illustrative implementation;

FIG. 2 is an example of a remote control device showing the front surface of the remote control device, according to an illustrative implementation;

FIG. 3 is another example of a remote control device showing the front surface of the remote control device, according to an illustrative implementation;

FIG. 4 is an example of a remote control device showing the back surface of the remote control device, according to an illustrative implementation;

FIG. 5 is a flow diagram depicting a method of remotely controlling an electronic device, according to an illustrative implementation;

FIG. 6 is a block diagram of a computer system in accordance with an illustrative implementation.

The foregoing and other aspects, embodiments, and features of the present teachings can be more fully understood from the following description in conjunction with the accompanying drawings.

### DETAILED DESCRIPTION

Following below are more detailed descriptions of various concepts related to a remote control device to control an electronic device. The various concepts introduced above and discussed in greater detail below may be implemented in any of numerous ways, as the described concepts are not limited to any particular manner of implementation. Examples of specific implementations and applications are provided primarily for illustrative purposes.

The remote control devices described herein can include buttons and other user interfaces that can be operated in the absence of backlight or other illumination. For example, the remote control device can include one or more touch pads to receive user input that is used to control an electronic device such as a smart television. The touch pad can include one or more panels. For example, a first panel or area of the touch pad can be used for receiving input to control cursor movement on a display of the electronic device that the remote control device is controlling. A second panel or area can be used for receiving input that is identified as text input and used to provide text as input to the electronic device.

The touch pad can receive various types of touch input from a user. For example, a north-south three-finger input generally parallel to the longitudinal axis of the remote control device (e.g., up/down) can be used to adjust the volume of an electronic device. In another example, a multi-finger input generally perpendicular to the longitudinal axis (e.g., left to right) of the remote control device can be used to change the channel.

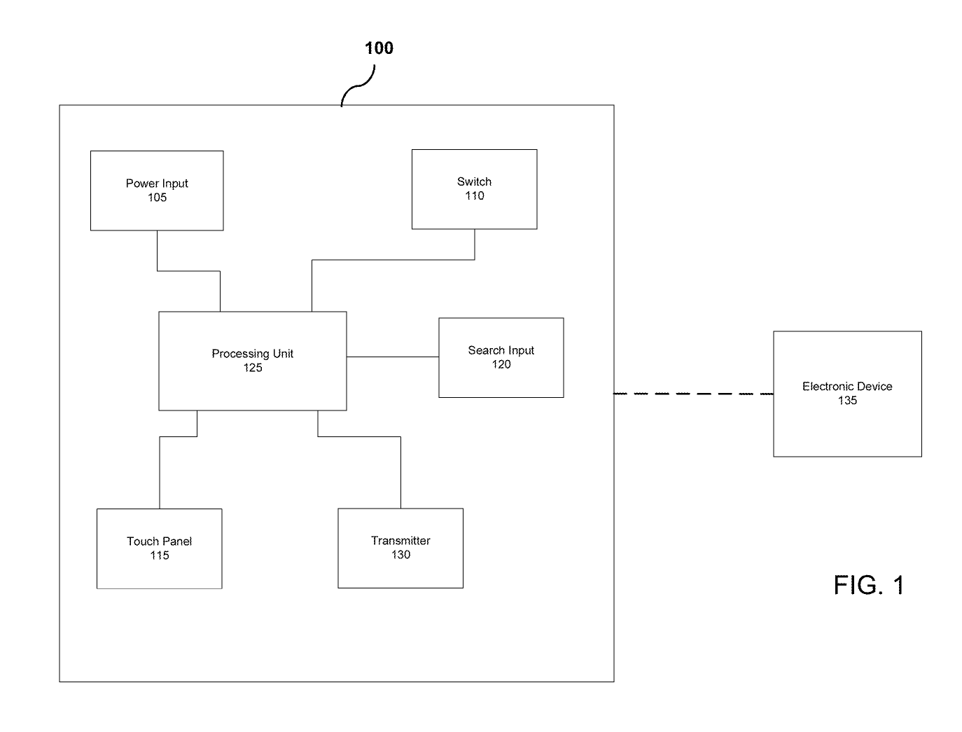

FIG. 1 is a block diagram depicting an example of a remote control device 100, according to an illustrative implementation. The remote control device 100 can include one or more power inputs 105, switches 110, touch panels 115, search inputs 120, processing units 125 (or processing circuits 125), and transmitters 130. For example, the touch panel 115 can receive input from a user. The processing unit 125 can receive this input, generate control data corresponding to the input, and provide the control data to the transmitter 130 for transmission to an electronic device 135 such as a television.

The power input 105 can include a terminal configured to receive a battery or other power supply. For example, the remote control device 100 can include a receptacle configured to receive a AAA size battery. In some implementations, the receptacle can be configured to receive a battery of other sizes, such as a AA size battery. The power input 105 can also include a socket to accept AC power via an AC adapter that can be plugged into an outlet on the wall.

In one implementation, the remote control device 100 includes at least one switch 110. For example, the switch 110 can be a button that when actuated by a user communicates with the electronic device 135 (e.g., via the transmitter 130) to turn it on and off. In some implementations, the switch 110 can be used to activate and deactivate both the electronic device 135 and the remote control device 100. For example, the switch 110 can put the remote control device 100 in a sleep mode, an on mode, or an off mode.

In one implementation, the remote control device 100 includes at least one touch panel 115. For example, the touch panel 115 can receive user input via a sensor and provide data corresponding to the user input to the processing unit 125. In some implementations, the touch panel 115 can receive user input. For example, the user input can be the touch of one or more of the user's fingers to the touch panel 115. In one implementation, the user input can be multi-touch user input when more than one of the user's fingers simultaneously contact the panel 115.

In some implementations, the touch panel 115 can be divided into more than one area (e.g., two, three, or more areas) and each area can be configured for a different purpose. For example, the touch panel 115 can receive a first input at a first area of the touch panel 115 and a second input at a second area of the touch panel 115. For example, the first area of the touch panel 115 can receive user input that is converted to instructions for cursor movement on the electronic device (e.g., a smart television). In one implementation, the first area can receive user input when one or more fingers simultaneously touch the first area of the touch panel 115. For example, a single-finger input to a portion of the touch panel 115 can be used to move a cursor displayed on the screen of the electronic device 135. A two-finger input can be used to zoom or rotate an on-screen object. In one implementation, a north-south three-finger input generally parallel to the longitudinal axis of the remote control device (e.g., up/down) can be used to adjust the volume of the electronic device 135. A west-east three-finger input generally perpendicular to the longitudinal axis (e.g., left to right) of the remote control device 100 can be used to change the channel of the electronic device 135. As described herein, the processing unit 125 can generate control data from this input to control the electronic device 135.

In some implementations, a second area of the touch panel 115 can receive user input representing text. For example, a user can use his fingers to write text, including normal handwriting and special shorthand writing, on the touch panel to operate the electronic device 135 to perform various functions. For example, the user can write the letter “M” on the touch panel 115. The processing unit 125 can interpret this input as representing the letter “M” and can provide instructions (e.g., via transmitter 130) to the electronic device 135 to display an electronic programming guide (e.g., a menu) on a screen of the electronic device 135. In another example, by writing the letter “A” on the touch panel 115, the processing unit 125 instructs the electronic device 135 to display channels in the channel list starting with the letter “A.” A single-finger touch input can be used to move the cursor of the electronic device 135 (e.g., a television) to the channel in the channel list that the user wishes to watch and a two-finger touch input can be used to select the channel. In one implementation, with multiple areas of the touch panel configured to receive different inputs, the remote control device 100 can perform functions that normally would require multiple devices, such as a computer keyboard and a computer mouse, for example.

The touch panel 115 can be a pressure sensitive touch panel. For example, the touch panel 115 can include a tactile sensor that is sensitive to touch, force, or pressure to translate the motion and position of a user's fingers to data corresponding to the motion and position of a user's fingers. In another example, the touch panel 115 can include a capacitive touch panel having at least one capacitive sensor to detect position, placement or acceleration of a user's fingers that contact the touch panel 115.

The touch panel 115 can also be operated in an absence of backlight or other illumination. For example, the remote control device can be used in a room without ambient light. In one implementation, the touch panel 115 can have a non-translucent surface that is not illuminated when a user is using the remote control device 100. In another implementation, the remote control device 100 can include a LED or other illumination source that is coupled with the processing unit 125. Responsive to input received at the switch 110 or touch panel 115, the LED can illuminate.

In one implementation, the remote control device 100 includes at least one search input 120. For example, the search input 120 can be a button that when actuated by a user sends control data to the electronic device 135 via the transmitter 130. The control data can be provided to the electronic device 135 to indicate that the user wants to make a search on the Internet. In this implementation, the electronic device 135 can access the Internet, for example via a wireless connection. The search input 120 can be actuated by pressing, for example, a search button on the remote control device 100. In another implementation, the search input 120 can be actuated by pressing the switch 110 or other power button that may also activate/deactivate the electronic device 135 and maintain the search input 120 in a depressed position for a period of time, such as a few seconds.

In one implementation, the processing unit 125 can receive input from the touch panel 115, generate control data from the input, and send the control data to the transmitter 130 to control the electronic device 135. For example, the processing unit 125 can include a logical device to execute a computer program to process user input received from the touch panel 115 and generate control data representing the input. In one implementation, the processing unit 125 processes control logic to divide the touch panel 115 into multiple areas and process the different inputs received from each area to generate different control signals, as described further herein.

In another implementation, the processing unit 125 can be implemented as an application specific integrated circuit (ASIC) which can receive input from the touch panel 115 and generate control data. An ASIC may be an integrated circuit customized for a particular use. In yet another implementation, the processing unit 125 can be implemented as a system on a chip (SOC) which can receive input from the touch panel 115 and generate control data. A SOC may include an integrated circuit that integrates all components of an electronic system into a single chip.

In one implementation, the processing unit 125 determines what type of user input is received from the touch panel 115 and generates control data corresponding to the type of user input. For example, the processing unit 125 can detect that the first user input is received at the first area of the touch panel 115. The first area of the touch panel 115 can be physically delineated on the remote control device 100, or be a logical area identified by the processing unit 125. The processing unit 125 can generate first control data representing the first input, which for example can control movement of a cursor on the electronic device 135. The processing unit 125 can also detect the second user input received at the second area of the touch panel 115 and generate second control data, which for example can identify text corresponding to the second input. In another implementation, the processing unit 125 can identify input received from one of the multiple areas of the touch panel 115 as being in a foreign language (e.g., not English) and can provide instructions for the electronic device 135 to display text in the foreign language.

In one implementation, the transmitter 130 of the remote control device 100 can receive control data from the processing unit 125 and provide this data to the electronic device 135. The transmitter 130 can be an infrared transmitter configured to send infrared pulses representing the control data to the electronic device 135. For example, the infrared transmitter can be implemented as an infrared light emitting diode which can be built into a pointing end of the remote control device 110 generally oriented toward the electronic device 135. In another implementation, the transmitter 130 can include a Bluetooth enabled transmitter to exchange data over short distances among devices with high level of security. In another implementation, the transmitter 130 can include a Wifi enabled transmitter to exchange data among wireless devices. In one implementation, the transmitter 130 includes a Bluetooth enabled transmitter or a Wifi enabled transmitter that does not use an infrared light emitting diode and thus the transmitter 130 does not have to point toward the electronic device 135 to transmit data to the electronic device 135.

The electronic device 135 can receive the control data (e.g., infrared signals) sent from the remote control device 100, process the control data, and perform functions indicated by the control data. For example, the electronic device 135 can perform functions such as powering up/down, changing the channel, changing the volume, or searching the Internet. The electronic device 135 can include, for example, a television, a set top box, a digital video recorder, a smart television, a computer, monitor, a tablet computer, a portable digital assistant, a smart phone, and a laptop computer.

In one implementation, the remote control device 100 can be used to operate an electronic device 135, such as a smart television or smart TV. A smart TV can include a processor configured to process the control data received from the remote control device 100 and perform or instruct other components of the smart TV to perform various functions indicated by the control data. The processor can integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. For example, the remote control device 100 described herein can send control data to the smart TV module to instruct the smart TV to display the electronic programming guide to the user.

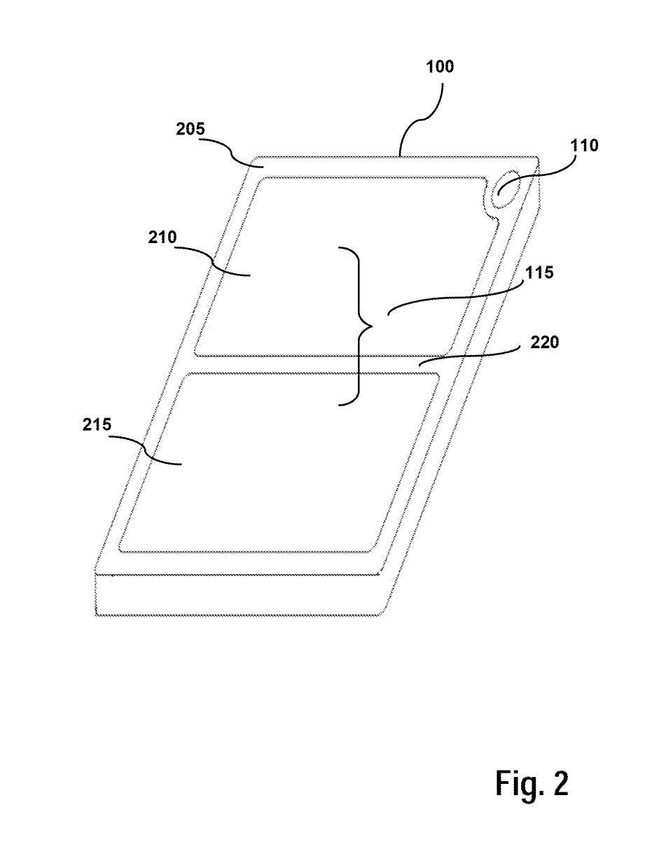

FIG. 2 is an example of a remote control device showing the front surface of the remote control device 100, according to an illustrative implementation. The remote control device 100 can include the switch 110, a housing 205, a first area 210 of the touch panel 115, a second area 215 of the touch panel 115, and a touch panel divider 220. For example, the touch panel divider 220 can divide the touch panel 115 into the first area 210 and the second area 215.

In one implementation, the switch 110 can be part of a power button. For example, as shown in FIG. 2, the power button can be placed asymmetrically on the housing 205 (e.g., in the upper right hand corner). The power button can be made of various materials, for example, rubber or other materials, etc. In one implementation, the switch 110 can also include the search input 120. For example, the switch 110 and the search input 120 can be implemented as one button that can implement the functions of the switch 110 and the search input 120.

In one implementation, the housing 205 is an outer surface of the remote control device 100. For example, the housing 205 can be a plastic case that offers a degree of shock resistance or protection from contamination from debris such as food or fluid. The housing 205 can be made of various materials, for example, plastic or other synthetic materials. The housing 205 can also be of different shapes. For example, the housing 205 can be rectangular, square, round, oval, or irregular.

The remote control device 100 can have various sizes. For example, in one implementation, the remote control device 100 can have a length of 5.0 to 6.0 inches, a width of 2.5 to 3.5 inches, and a thickness of less than 0.6 inches. In another implementation, the remote control device can have a length of 3.5 to 4.5 inches, a width of 1.5 to 2.5 inches, and a thickness of less than 0.5 inches. These dimensions are examples and other larger and smaller dimensions are possible.

In one implementation, the remote control device 100 includes at least one touch panel divider 220. The divider 220 can be a strip made of plastic or other material that is part of the housing 205 and lays on top of the touch panel 115. The divider 220 and the housing 205 can define the first area 210 and the second area 215 of touch panel 115. In one implementation, there is no divider and thus just one single touch panel 115.

In one implementation, the first area 210 and the second area 215 can both be part of the touch panel 115, as a single panel divided into two parts. In another implementation, the first area 210 and the second area 215 can be two different touch panels that are installed as separate physical panels. Although FIG. 2 shows two areas of the touch panel 115, in some implementations, there can be more than two areas, and the areas can have different shapes other than rectangular. Each area may receive different forms of input from the user. The first area 210 and the second area 215 do not have to be divided equally in size.

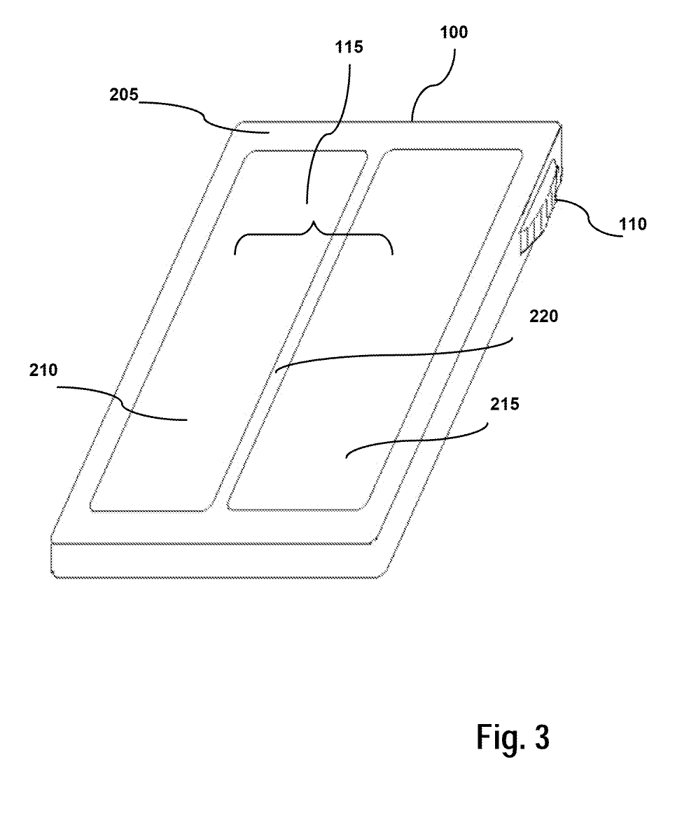

FIG. 3 is a another example of a remote control device 100 showing the front surface of the remote control device 110, according to an illustrative implementation. In FIG. 3, the housing 205, the first area 210 of the touch panel 115, the second area 215 of the touch panel 115, and the touch panel divider 220 can be the same as those in FIG. 2. The first area 210 and the second area 215 can also be divided in the direction as that is shown in FIG. 2. In one implementation, the switch 110 can be part of a knob or dial. The knob can be located on one lateral side of the remote control device 100, as shown in FIG. 3. Other locations (e.g., on the top, front, bottom, or back) are possible. In one implementation, the knob can have different selectable positions. Depending on various implementations, the knob can be rotated to different selectable positions to activate and deactivate the electronic device 135 and/or the remote control device 100. In one implementation, the search input 120 can be actuated by rotating the knob to a specific selectable location.

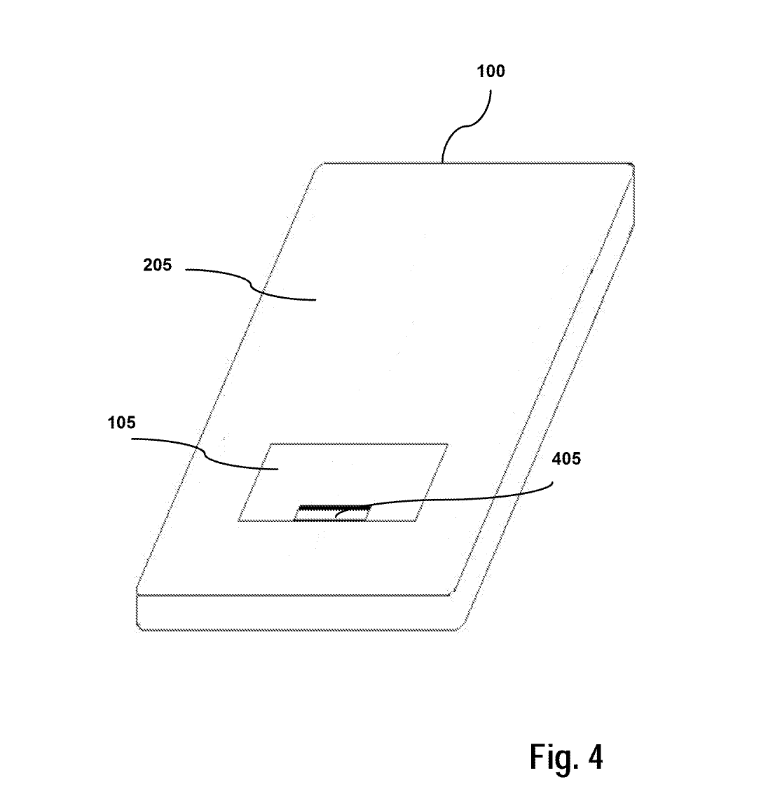

FIG. 4 is an example of a remote control device showing the back surface of the remote control device 110, according to an illustrative implementation. For example, the remote control device 100 can include the housing 205, the power input 105, and a latch 405. FIG. 4 shows the back surface of the housing 205. In one implementation, the power input 105 can be a receptacle that can have a lid with a latch 405. The latch 405 can be used to open or close the cover, and to insert or remove the battery. As discussed previously, the battery can be of various sizes, such as AAA size, AA size, etc.

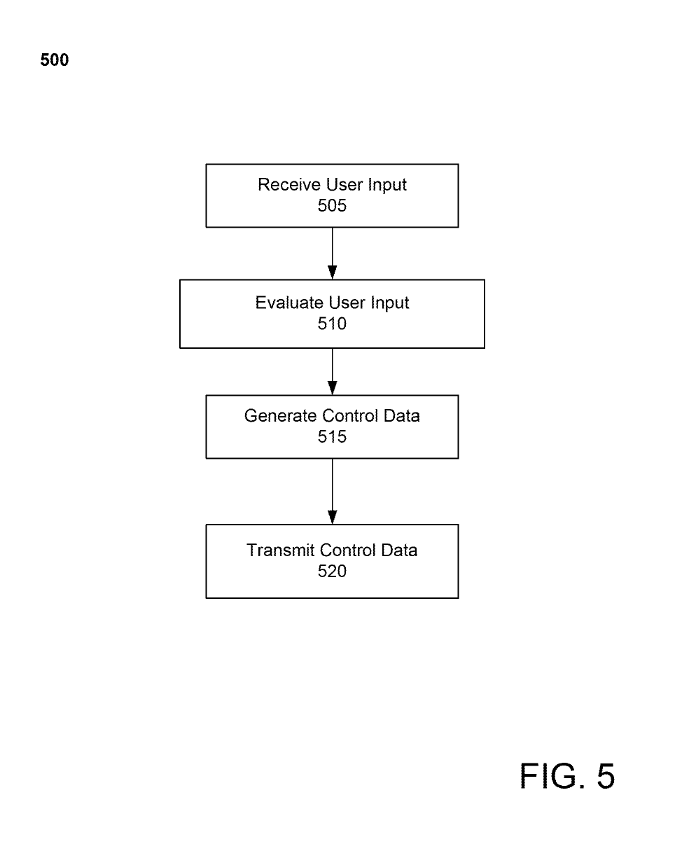

FIG. 5 is a flow diagram depicting a method of remotely controlling an electronic device 110, according to an illustrative implementation. The method 500 can receive a user input at a remote control device (BLOCK 505). In one implementation, the received input (BLOCK 505) includes a first input and a second input. For example, the first input can be received at a first area of the touch panel and the second input can be received at a second area of the touch panel. In one implementation, the first area and the second area of the touch panel can be physically separate areas. In another implementation, the first area and the second area of the touch panel can be different areas of the same touch panel that are logically separated by software executed by the processing unit. In another implementation, the received user input (BLOCK 505) includes a search command received via a button that is pressed by the user.

The method 500 can evaluate the user input to identify the type of the user input (BLOCK 510). For example, a processing unit can evaluate the user input (BLOCK 510). In one implementation, the processing unit can evaluate the user input (BLOCK 510) to identify whether the input represents text characters or cursor movement on the electronic device. In another implementation, the processing unit can evaluate the user input (BLOCK 510) to identify whether the input is in a foreign language, for example.

The method 500 can generate control data representing the user input (BLOCK 515). For example, the control data can be generated by the processing unit from the received user input (BLOCK 505). In one implementation, the processing unit generates control data (BLOCK 515) that can control a cursor display or a text display on the electronic device. In another implementation, the processing unit generates control data (BLOCK 515) that can be used to request an Internet search on the electronic device.

The method 500 can transmit at least one of the first control data and the second control data from the remote control device to a receiver of the electronic device (BLOCK 520). For example, the control data can be transmitted using the transmitter that is part of the remote control device. In one implementation, the control data is transmitted (BLOCK 520) by an infrared transmitter to a receiver of the electronic device. In another implementation, the control data is transmitted (BLOCK 520) by a Bluetooth enabled transmitter. In yet another implementation, the control data is transmitted (BLOCK 520) by a Wifi enabled transmitter.

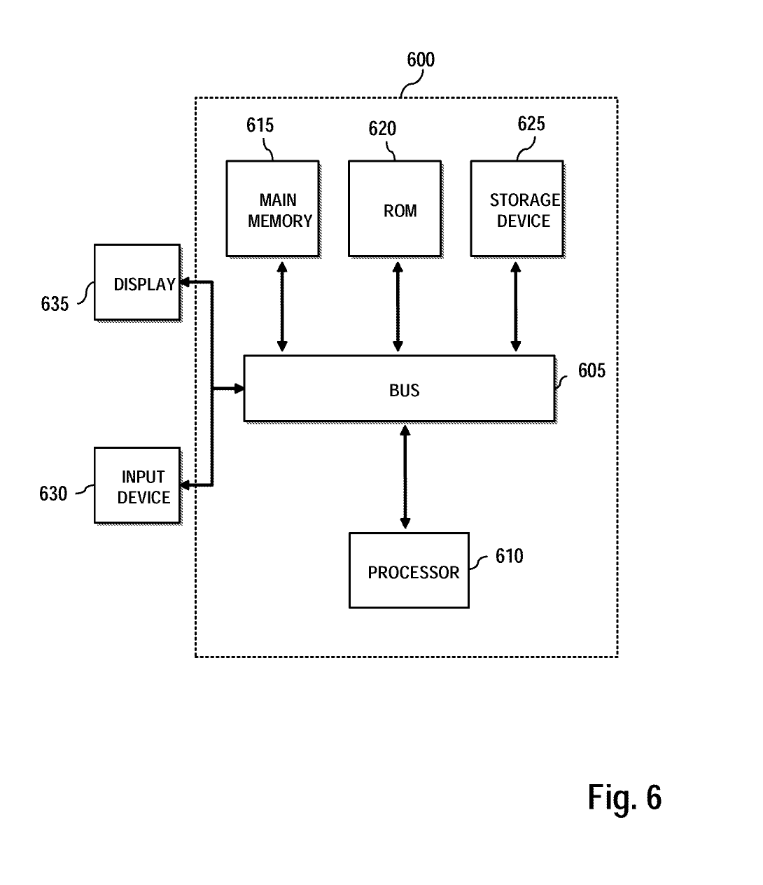

FIG. 6 is a block diagram of a computer system in accordance with an illustrative implementation. The computer system or computing device 600 can be used to implement the electronic device 135. In some implementations, the computer system or computing device 600 can also be used to implement the processing unit 125. The computing system 600 includes a bus 605 or other communication component for communicating information and a processor 610 or processing circuit coupled to the bus 605 for processing information. The computing system 600 can also include one or more processors 610 or processing circuits coupled to the bus for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630 may be coupled to the bus 605 for communicating information and command selections to the processor 610. In one implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various implementations, the processes or operations described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example computing system has been described in FIG. 6, implementations of the subject matter and the functional operations described in this specification can be implemented in other types of digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The terms “processor” or “processing circuit” or “processing unit” or “data processing apparatus” or “computing device” encompass all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special-purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A remote control device, comprising:
a switch configured to activate and deactivate both an electronic device and the remote control device;
a power input configured to receive electrical power;
a touch panel configured to operate in an absence of backlight, wherein the touch panel is further configured to receive a first input at a first area of the touch panel, and a second input at a second area of the touch panel;
a processing unit coupled with the switch, the power input, and the touch panel, the processing unit configured to provide first control data representing the first input, wherein the first control data controls movement of a cursor on the electronic device, and the processing unit configured to provide second control data representing the second input, wherein the second control data identifies text corresponding to the second input; and
a transmitter coupled to the processing unit, the transmitter configured to provide the control data to the electronic device.

2. The remote control device of claim 1, wherein the touch panel is non-translucent.

3. The remote control device of claim 1, further comprising:
a housing, wherein the housing is configured to divide the touch panel into the first area and the second area.

4. The remote control device of claim 1, further comprising:
a search input, wherein in response to actuation of the search input the remote control device is configured to send a signal to a television controller requesting an Internet search.

5. The remote control device of claim 1, wherein the electronic device includes at least one of a television, set top box, digital video recorder, smart television, computer, monitor, tablet computer, portable digital assistant, smart phone, or laptop computer.

6. The remote control device of claim 1, wherein the switch includes a power button, and wherein the power input is configured to receive electrical power from a battery.

7. The remote control device of claim 1, wherein the remote control device has a length of 5.0 to 6.0 inches, a width of 2.5 to 3.5 inches, and a thickness of less than 0.6 inches.

8. The remote control device of claim 1, wherein the remote control device has a length of 3.5 to 4.5 inches, a width of 1.5 to 2.5 inches, and a thickness of less than 0.5 inches.

9. The remote control device of claim 1, wherein the power input is configured to receive a AAA size battery.

10. The remote control device of claim 1, further comprising:
a LED coupled with the processing unit, wherein the LED is configured to illuminate responsive to input received at one of the switch and the touch panel.

11. The remote control device of claim 1, wherein the transmitter includes at least one of an infrared transmitter or a Bluetooth enabled transmitter.

12. The remote control device of claim 1, wherein the touch panel includes at least one of a capacitive touch panel or a pressure sensitive touch panel.

13. A remote control device, comprising:
a switch configured to activate and deactivate both an electronic device and the remote control device;
a power input configured to receive electrical power;
a touch panel configured to operate in an absence of backlight, wherein the touch panel is further configured to receive a first input at a first area of the touch panel, and a second input at a second area of the touch panel;
means for providing first control data representing the first input, wherein the first control data controls movement of a cursor on the electronic device, and second control data representing the second input, wherein the second control data identifies text corresponding to the second input; and
a transmitter configured to provide the control data from the remote control device to the electronic device.

14. The remote control device of claim 13, further comprising:
a housing, wherein the housing is configured to divide the touch panel into the first area and the second area.

15. The remote control device of claim 13, further comprising:
a search input, wherein in response to actuation of the search input the remote control device is configured to send a signal to a television controller requesting an Internet search.

16. The remote control device of claim 13, wherein the switch includes a power button, and wherein the power input is configured to receive electrical power from a battery.

17. The remote control device of claim 13, wherein the transmitter includes at least one of an infrared transmitter or a Bluetooth enabled transmitter.

18. The remote control device of claim 13, wherein the touch panel includes at least one of a capacitive touch panel or a pressure sensitive touch panel.

19. A method of remotely controlling an electronic device, comprising:
receiving a user input at a remote control device, wherein the remote control device includes:
a switch configured to activate and deactivate both an electronic device and the remote control device,
a power input configured to receive electrical power,
a touch panel configured to operate in an absence of backlight, wherein the touch panel is further configured to receive a first input at a first area of the touch panel, and a second input at a second area of the touch panel;
a processing unit coupled with the switch, the power input, and the touch panel, and
a transmitter coupled to the processing unit;
evaluating, using the processing unit, the user input to identify the user input as one of the first input received at the first area of the touch panel and the second input received at the second area of the touch panel;
generating, using the processing unit, control data representing the user input, wherein the control data is one of a first control data representing the first input to control movement of a cursor on the electronic device and a second control data representing the second input to identify text corresponding to the second input; and
transmitting, using the transmitter, at least one of the first control data and the second control data from the remote control device to a receiver of the electronic device to control at least one of a cursor display and a text display on the electronic device.

20. The remote control method of claim 19, further comprising:
receiving a search command via a search button on the remote control device;
generating, using the processing unit, search control data representing the search command; and
transmitting, using the transmitter, search control data from the remote control device to the receiver of the electronic device to request an Internet search.
